(19) United States
(12) Patent Application Publication
(10) Pub. No.: US 2017/0002592 A1
(43) Pub. Date: Jan. 5, 2017

(54) Door Holding Device

(71) Applicant: Ramon Cervantes, JR., Dallas, TX (US)

(72) Inventor: Ramon Cervantes, JR., Dallas, TX (US)

(21) Appl. No.: 15/063,542

(22) Filed: Mar. 8, 2016

Related U.S. Application Data
(60) Provisional application No. 62/177,268, filed on Mar. 10, 2015.

(51) Int. Cl. E05C 17/56; E05F 5/02

(52) U.S. Cl. CPC E05C 17/56; E05F 5/025; E05Y 2900/531

(57) ABSTRACT

A door holding device for selectively holding and releasing a vehicle door may include a door holding arm being connected to a vehicle and slidably connected to a door of the vehicle; a plunger shaft for selectively engaging the door holding arm; a guide pin; and a channel; a guide block to guide the plunger shaft; a bearing to stabilize the travel of the door holding arm.

### FIELD OF THE INVENTION

The present invention relates to a door holding device and more particularly to a device to freeze the motion of a vehicle door by switches and electrical solenoids.

### BACKGROUND

Vehicle doors especially automobile doors can be heavy and cumbersome for the user of the doors especially the young and old. The automobile doors can be extremely heavy and present a burden to open and close. When opening the doors, gravity or other conditions such as high winds may cause these doors begin to close before the user of the door has had the opportunity to exit the vehicle. This may be a dangerous situation if the user has already placed a leg or an arm outside of the door. The slamming door can be painful and can cause injuries to the user, and the user may not have enough strength to prevent the door form slamming. Under these circumstances, it is desirable to have a mechanism to freeze the motion of the door without using the strength of the user. Furthermore, millions of dollars may be saved from preventing these types of injuries to persons and preventing damages to other vehicles.

### SUMMARY

A door holding device for selectively holding and releasing a vehicle door may include a door holding arm being connected to a vehicle and slidably connected to a door of the vehicle; a plunger shaft for selectively engaging the door holding arm; a guide block to guide the plunger shaft; a bearing to stabilize the travel of the door holding arm.

The door holding arm may include teeth to engage the plunger shaft.

The bearing may be biased by a bias device.

The bias device may be a spring.

The door holding arm may include a channel.

The bearing may include a ball bearing.

The plunger shaft may be controlled by a switch.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the front of the door holding device of the present invention;

FIG. 2 illustrates a cross-sectional side view of the door holding device of the present invention;

FIG. 3 illustrates a cross-sectional view of a portion of the door holding device of the present invention;

FIG. 4 illustrates a top cross-sectional view of the door holding device of the present invention;

FIG. 5 illustrates a bottom cross-sectional view of the door holding device of the present invention; and

FIG. 6 illustrates an electrical switch and fuse box.

### DETAILED DESCRIPTION

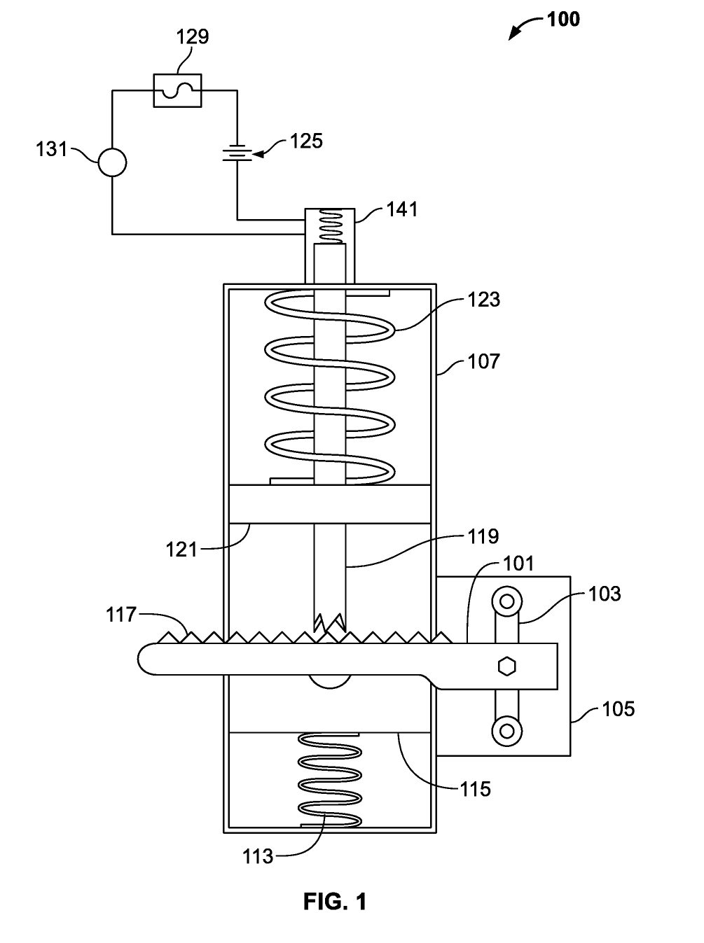

FIG. 1 illustrates a cross-sectional view of the front of the door holding device 100 of the present invention and illustrates a door holding arm 101 which may be connected to support device 103 which may be a bracket attached to the vehicle 105 to support the door holding arm 101. The door holding arm 101 may extend into a door of the vehicle 105. FIG. 1 additionally illustrates a housing 107 to house the door holding device 100 of the present invention. As the door of the vehicle 105 opens, the housing 107 and the door holding device 100 moves along the door holding arm 101, and as the door of the vehicle 105 closes, the housing 107 and the device 100 moves along the door holding arm 101 in the opposite direction than when the door is opening. The door holding arm 101 may include a channel 109 to mate with a bearing 111 which may be a ball bearing to stabilize the door holding arm 101 as the housing 107 moves with respect to the door holding arm 101. The door holding arm 101 may include teeth 117 which may be opposed to the channel 109. The teeth 107 may mate with an end of a plunger shaft 119 which may extend longitudinally in the housing 107. The plunger shaft 119 may extend through an aperture of a guide block 121 which may act as a collar for the plunger shaft 119 to stabilize the plunger shaft 119.

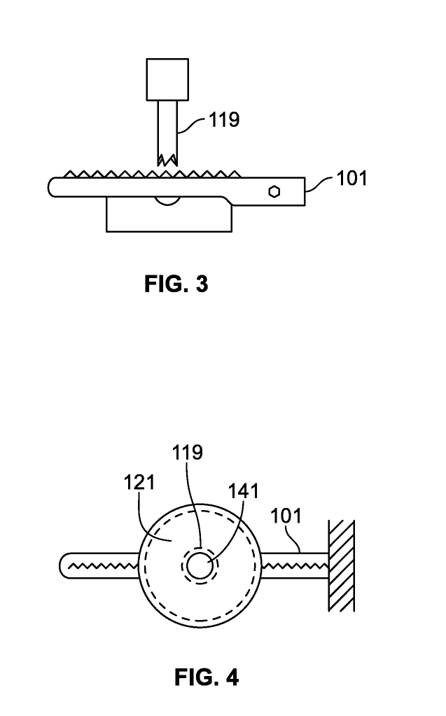

The plunger shaft 119 may engage the teeth 117 in order to stop the movement of the door holding arm 101 which may prevent the door from moving either open or closed and preventing an injury to the user of the door. The plunger shaft 119 may be withdrawn from the teeth 117 (see FIG. 3) in order to allow the door holding arm 101 to move relatively freely with respect to the housing 107, allowing the door of the vehicle 105 to move freely allowing the user to enter and exit the vehicle 105. A plunger coil 123 may be energized in order to moves the plunger shaft 119 to engage or disengage with the teeth 117. The plunger coil 123 may be connected to a battery 125 which may be the car battery such as 12 V battery which may be connected to a fuse box 127 and connected to switch 131 in order to control the plunger coil 123 and control the plunger shaft 119.

The bearing 111 may cooperate with a biasing device 113 which may include a spring to bias the bearing 111 in order to stabilize the door holding arm 101. The spring may be connected to a movable wall 115 which extends and retracts within the housing 107.

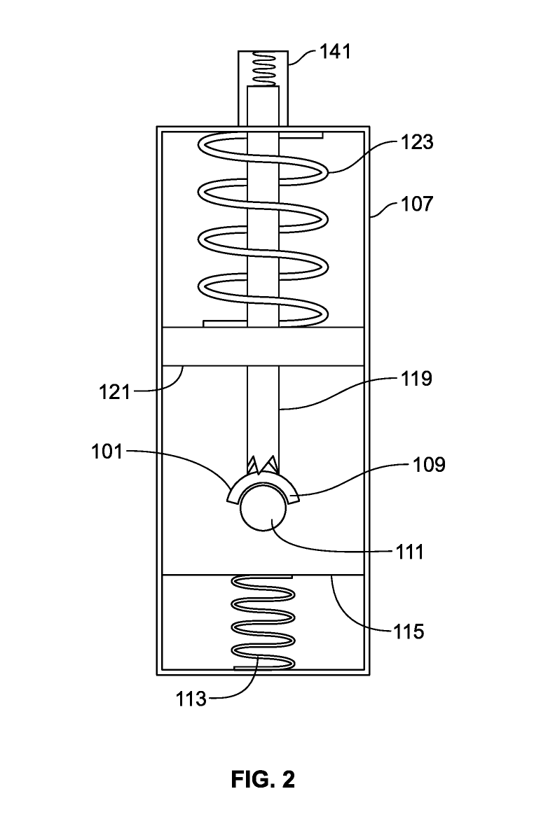

FIG. 2 illustrates a cross-sectional view of the side of the door holding device 100 of the present invention and illustrates a door holding arm 101 which may be connected to support device 103 which may be a bracket attached to the vehicle 105 to support the door holding arm 101. The door holding arm 101 may extend into a door of the vehicle 105. FIG. 1 additionally illustrates a housing 107 to house the door holding device 100 of the present invention. As the door of the vehicle 105 opens, the housing 107 and the door holding device 100 moves along the door holding arm 101, and as the door of the vehicle 105 closes, the housing 107 and the device 100 moves along the door holding arm 101 in the opposite direction than when the door is opening. The door holding arm 101 may include a channel 109 to mate with a bearing 111 which may be a ball bearing to stabilize the door holding arm 101 as the housing 107 moves with respect to the door holding arm 101. The door holding arm 101 may include teeth 117 which may be opposed to the channel 109. The teeth 107 may mate with an end of a plunger shaft 119 which may extend longitudinally in the housing 107. The plunger shaft 119 may extend through an aperture of a guide block 121 which may act as a collar for the plunger shaft 119 to stabilize the plunger shaft 119.

The plunger shaft 119 may engage the teeth 117 in order to stop the movement of the door holding arm 101 which may prevent the door from moving either open or closed and preventing an injury to the user of the door. The plunger shaft 119 may be withdrawn from the teeth 117 (see FIG. 3) in order to allow the door holding arm 101 to move relatively freely with respect to the housing 107, allowing the door of the vehicle 105 to move freely allowing the user to enter and exit the vehicle 105. A plunger coil 123 may be energized in order to moves the plunger shaft 119 to engage or disengage with the teeth 117. The plunger coil 123 may be connected to a battery 125 which may be the car battery such as 12 V battery which may be connected to a fuse box 127 and connected to switch 131 in order to control the plunger coil 123 and control the plunger shaft 119.

The bearing 111 may cooperate with a biasing device 113 which may include a spring to bias the bearing 111 in order to stabilize the door holding arm 101. The spring may be connected to a movable wall 115 which extends and retracts within the housing 107.

FIGS. 1 and 2 show the door holding arm 101 being locked by the plunger shaft 119 in a first position, and FIGS. 1 and 2 show the actuator 141 to raise and lower the plunger shaft 119 by energizing the plunger coil 123.

FIG. 3 shows the door holding arm 101 being unlocked and able to travel unrestrained by the plunger 119 in a second position.

FIG. 4 illustrates a top view of the door holding device 100 and illustrates the actuator 141, the door holding arm 101 and the guide block (collar) 121.

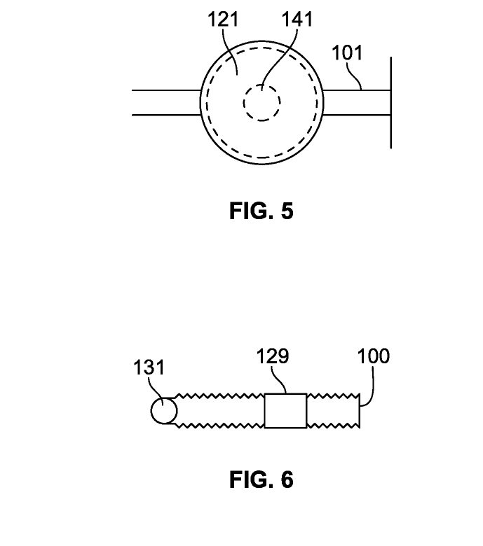

FIG. 5 illustrates a bottom view of the door holding device 100 of the present invention and illustrates the door holding arm 101, the solenoid 141 and the guide block (collar) 121.

FIG. 6 illustrates the switch 131 which may be connected to the fuse 129 which may be connected to the solenoid 141.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A door holding device for selectively holding and releasing a vehicle door, comprising:
a door holding arm being connected to a vehicle and slidably connected to a door of the vehicle;
a plunger shaft for selectively engaging the door holding arm;
a guide block to guide the plunger shaft;
a bearing to stabilize the travel of the door holding arm.

2) A door holding device for selectively holding and releasing a vehicle door as in claim 1, wherein the door holding arm includes teeth to engage the plunger shaft.

3) A door holding device for selectively holding and releasing a vehicle door as in claim 1, wherein the bearing is biased by a bias device.

4) A door holding device for selectively holding and releasing a vehicle door as in claim 3, wherein the bias device is a spring.

5) A door holding device for selectively holding and releasing a vehicle door as in claim 1, wherein the door holding arm includes a channel.

6) A door holding device for selectively holding and releasing a vehicle door as in claim 1, wherein the bearing includes a ball bearing.

7) A door holding device for selectively holding and releasing a vehicle door as in claim 1, wherein the plunger shaft is controlled by a switch.
